(19) United States
(12) Patent Application Publication
(10) Pub. No.: US 2010/0282993 A1
(43) Pub. Date: Nov. 11, 2010

(54) Continuous Flow Bypass Manifold

(76) Inventors: Timothy Robert Kerrigan, Waukesha, WI (US); Russell John Steinmetz, Port Washington, WI (US)

Correspondence Address: REINHART BOERNER VAN DEUREN S.C.;ATTN: LINDA KASULKE, DOCKET COORDINATOR, 1000 NORTH WATER STREET, SUITE 2100, MILWAUKEE, WI, 53202, US

(21) Appl. No.: 12/463,456

(22) Filed: May 11, 2009

(51) Int. Cl. F16K 31/44

(52) U.S. Cl. 251/231

(57) ABSTRACT

A continuous flow bypass manifold comprising a fixed portion and an attachment portion for removable connection with the fixed portion. The fixed portion, fixedly installed into a fluidic system, defines a flow path and comprises inlet and outlet ports, a bypass valve disposed in the flow path, a bypass outlet tube proximate the inlet port, and a bypass inlet tube proximate the outlet port. Two attachment tubes can be coupled to at least one flow-through series component and attached to the bypass outlet and inlet tubes to form an alternate flow path through the at least one flow-through, series component upon manipulation of the bypass valve to close the flow path through the fixed portion and divert the fluid to flow through the flow-through series component. This addition of a series component is accomplished without disassembling and/or reassembling the fluidic system or interrupting fluid flow.

### BACKGROUND OF THE INVENTION

1. Field of the Invention

The present invention relates generally to a continuous flow bypass manifold, and more specifically, to a device that allows adding and removing flow-through components into a fluid circuit without interrupting the fluid circuit's fluid flow.

2. Background

It is sometimes necessary to add or remove a flow-through component or components in series with a fluidic system. However, it may be undesirable that the flow-through component or components remain as a fixed part of the fluidic system. Many such flow-through series components are unable to endure the normal operating environment of the fluidic system for an extended period of time, and therefore, it is necessary to remove such components from the fluidic system following their use. Examples of such flow-through series components include particle counters, temperature gages, pressure gages, fluid filters, and flow meters, among other components.

In the past, the installation or removal of a flow-through series component from a fluidic system would require a disruption of the flow of the fluidic system for a period of time so that the fluidic system could be disassembled, the component could be installed or removed, and the fluid system could be reassembled. Also, the fluidic system may be required to be drained, fluid from the system could be lost, and contaminants could gain ingress into the system.

Thus, it would be advantageous to be able to add or remove flow-through series components in a fluidic system.

It would further be advantageous to be able to add or remove flow-through series components in a fluidic system without disassembling and/or reassembling the fluidic system.

Additionally, it would be advantageous to be able to add or remove flow-through series components in a fluid circuit without disrupting or being forced to discontinue the fluid flow through the fluidic system for a period of time.

It would further be advantageous to be able to add or remove flow-through series components in a fluidic system without the loss of any fluid from the system.

It would also be advantageous to be able to add or remove flow-through series components in a fluidic system by a controlled method that would prevent the ingress of any contaminants into the fluid.

It would also be advantageous to be able to install flow-through series components in a fluidic system in such a way as to prevent removal of the flow-through series components without returning the flow path to normal state.

A device capable of achieving these advantages must also be of a construction which is both durable and long lasting, and which would also require little or no maintenance to be provided by the user throughout its operating lifetime. In order to enhance the market appeal of such a device, it should also be of relatively inexpensive construction to thereby afford it the broadest possible market. Finally, it is also an objective that all of the aforesaid advantages and objectives of such a device be achieved without incurring any substantial relative disadvantage.

### SUMMARY OF THE INVENTION

The present invention provides a continuous flow bypass manifold that may be coupled in series with a fluidic system containing a fluid flowing therethrough. The continuous flow bypass manifold includes two portions, a fixed portion and an attachment portion. The fixed portion includes a valve housing defining a flow path between an inlet port and an outlet port, with a bypass valve being located intermediate the inlet port and the outlet port. The fixed portion also includes a bypass outlet tube proximate the inlet port and in fluid communication therewith, and a bypass inlet tube proximate the outlet port and in fluid communication therewith. When the bypass valve is in an open configuration, the fluid passes in from the inlet port, through the bypass valve, and out through the outlet port. Coupled to the bypass outlet tube at a distal end thereof is a first mating connector. Coupled to the bypass inlet tube at a distal end thereof is a second mating connector. These mating connectors have self-closing valves that are in a normally closed configuration when the mating connectors do not have other mating connectors connected thereto to prevent fluid from flowing out of the distal ends of the mating connectors.

The continuous flow bypass manifold also includes an attachment portion including a first attachment tube and a second attachment tube coupled to and spaced apart from the first attachment tube. The attachment portion also includes at least one flow-through series component coupled to the first and second attachment tubes at proximal ends thereof. The first and second attachment tubes are in fluid communication with each other through the flow-through series component. Coupled to the first attachment tube at a distal end thereof, is a third mating connector. Coupled to the second attachment tube at a distal end thereof is a fourth mating connector. The third and fourth mating connectors will facilitate coupling the attachment portion to the fixed portion.

To place the flow-through series component in series with the fluidic system, the attachment portion is attached to the fixed portion. This is accomplished by coupling the first mating connector to the third mating connector, and simultaneously coupling the second mating connector to the fourth mating connector. When the respective pairs of mating connectors are so coupled, the self-closing valves in the first and second mating connectors opened, thereby allowing fluid to flow through and out of them. The bypass valve may subsequently be closed, thereby preventing fluid from flowing directly between the inlet port and the outlet port.

The fluid is instead diverted from the inlet port through the bypass outlet tube, through the first attachment tube, through the flow-through series component, through the second attachment tube, through the bypass inlet tube, and to the outlet port.

The continuous flow bypass manifold also includes an interlock mechanism located proximate the bypass valve, integrally formed in the valve housing proximate to the bypass outlet and bypass inlet tubes. The interlock mechanism performs two functions. First, the interlock mechanism prevents the bypass valve from being closed when the attachment portion is not attached to the fixed portion. Second, the interlock mechanism prevents the attachment portion from being removed from the fixed portion when the bypass valve is in a closed configuration.

The continuous flow bypass manifold of the present invention is of a construction which is both durable and long lasting, and it should also require little or no maintenance to be provided by the user throughout its operating lifetime. The continuous flow bypass manifold of the present invention is also of relatively inexpensive construction to enhance its market appeal and to thereby afford it the broadest possible market. Finally, continuous flow bypass manifold of the present invention achieves all of the aforesaid advantages and objectives without incurring any substantial relative disadvantage.

### DESCRIPTION OF THE DRAWINGS

These and other advantages of the continuous flow bypass manifold are best understood with reference to the drawings, in which:

FIG. 1 is an isometric view of an exemplary embodiment of a continuous flow bypass manifold;

FIG. 2 is a partially exploded view of the continuous flow bypass manifold shown in FIG. 1;

FIG. 3 is a partial exploded view of a valve lever handle configured to engage a valve stem in the continuous flow bypass manifold shown in FIGS. 1 and 2;

FIG. 4 is a partial view of the continuous flow bypass manifold shown in FIGS. 1 through 3 with the valve housing removed to show the apparatus in a configuration with the bypass valve open;

FIG. 5 is a partial view of the continuous flow bypass manifold shown in FIGS. 1 through 4 with the valve housing removed to show the apparatus in a configuration with the bypass valve closed;

FIG. 6 is a plan view of the continuous flow bypass manifold shown in FIGS. 1 through 5 with the valve housing shown in partial cross-section to illustrate the flow of fluid when the bypass valve is in an open configuration, as shown in FIG. 4;

FIG. 7 is a detailed sectional view along the line 7-7 of FIG. 6 of the continuous flow bypass manifold shown in FIGS. 1 through 6;

FIG. 8 is a plan view of the continuous flow bypass manifold shown in FIGS. 1 through 7 with the valve housing shown in partial cross-section to illustrate the flow of fluid when the bypass valve is in a closed configuration, as shown in FIG. 5;

FIG. 9 is a detailed sectional view along the line 9-9 of FIG. 8 of the continuous flow bypass manifold shown in FIGS. 1 through 8;

FIG. 10 is a plan view of the continuous flow bypass manifold shown in FIGS. 1 through 9 with the valve housing shown in partial cross-section to illustrate removal of the attachment portion; and

FIG. 11 is a plan view of the continuous flow bypass manifold shown in FIGS. 1 through 10 with the valve housing shown in partial cross-section to illustrate the device after removal of the attachment portion.

### DETAILED DESCRIPTION OF THE EXEMPLARY EMBODIMENTS

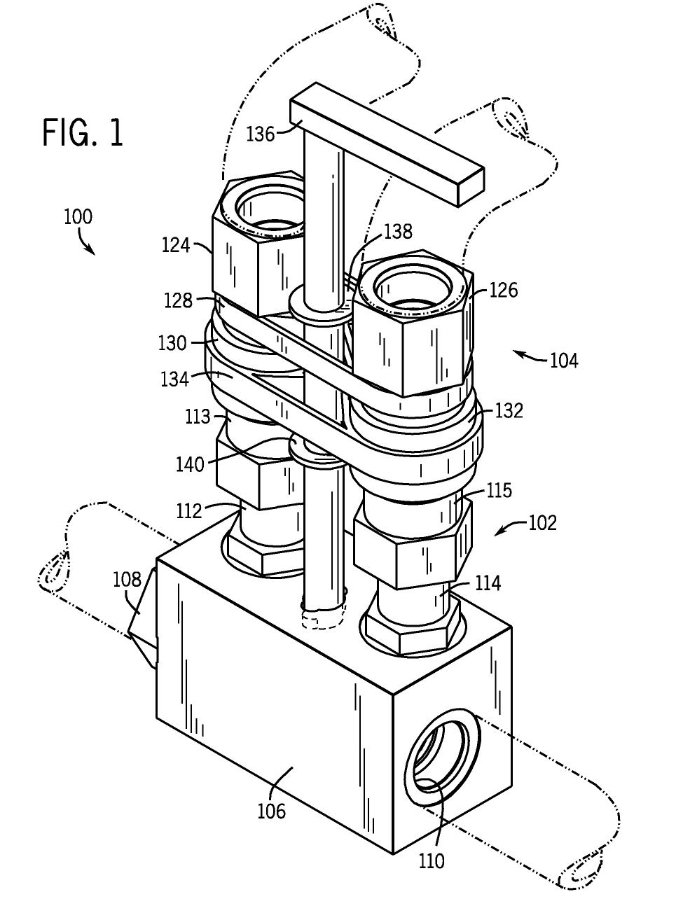

An embodiment of a continuous flow bypass manifold 100 is illustrated in FIG. 1. In one embodiment the continuous flow bypass manifold is formed from aluminum, however it is envisioned that the continuous flow bypass manifold could be formed from any metal suitable for the intended use, including but not limited to aluminum, steel, ductile iron, or combinations thereof, as well as plastics, composites, and other suitable materials. These materials are mentioned only as examples and are not meant to limit the invention, as various other materials are envisioned as well.

As will be further described below, an embodiment of a continuous flow bypass manifold 100 is configured to facilitate insertion and removal of at least one flow-through component in series with a fluidic system without interrupting the fluid flow within the system.

An embodiment of a continuous flow bypass manifold 100 contains a portion that is fixedly installed in a fluidic system, as well as a portion containing the at least one flow-through series component that can be removable attached to the fixed portion. Once the flow-through series component portion is attached, flow in the fluidic system is diverted from its normal operating flow path through the fixedly installed portion and is instead selectively directed through the at least one flow-through series component portion before being returned to the fluidic system. Once the at least one flow-through series component is no longer needed as part of the fluidic system, flow is once again directed back into the original flow path through the fixedly installed portion and the portion containing the at least one flow-through series component is removed. This entire process is performed without disassembling and reassembling the fluidic system. It is also accomplished without any fluid loss from the system, without interrupting the fluid flow, and without allowing any unwanted contaminants to be introduced into the fluidic system.

A fluid, for example, could be a liquid, gas, slurry, suspension, colloid, mixture, colloidal suspension, or any other material with fluidic flow properties. This list is not exhaustive and is given merely as an example. Other suitable fluids are contemplated.

Exemplary flow-through series components include particle counters, temperature gages, pressure gages, filter elements, and flow meters, among other components. Many other components are envisioned, including any components that for any reason it would be undesirable to permanently install in the fluid system.

In FIG. 1 an embodiment of the flow bypass manifold 100 comprises a fixed portion 102 and an attachment portion 104.

### Fixed Portion

The fixed portion 102 is fixedly installed as a component of the fluidic system and comprises a valve housing 106. The valve housing 106 defines a flow path from an inlet port 108 to an outlet port 110. During normal operation of the fluidic system, fluid from the fluidic system enters the valve housing 106 through the inlet port 108, passes through the flow path defined by the valve housing 106 and exits the valve housing 106 through the outlet port 110, reentering the fluidic system.

In one embodiment, the fixed portion 102 further comprises a bypass outlet tube 112 proximate the inlet port 108. The bypass outlet tube 112 is operably coupled to the valve housing 106, and is in fluid communication with the flow path. In one embodiment, the bypass outlet tube 112 is coupled to a first mating connector 113. The first mating connector 113 comprises a self-closing valve, meaning that when the first mating connector 113 is coupled to the bypass outlet tube 112 but is not coupled to another component distal from the bypass outlet tube 112, the first mating connector 113 remains in a normally closed configuration, preventing fluid from flowing out of the end of the first mating connector 113 distal from the bypass outlet tube 112. In one embodiment the first mating connector 113 is a male quick disconnect coupling, such as an ISO 16028 generic industry standard type coupling produced, for example by Snap-tite, Inc., although other suitable types of quick disconnect couplings are envisioned.

In one embodiment, the fixed portion 102 further comprises a bypass inlet tube 114 proximate the outlet port 110. The bypass inlet tube 114 is operably coupled to the valve housing 106, and is in fluid communication with the flow path. In one embodiment, the bypass inlet tube 114 is coupled to a second mating connector 115. The second mating connector 115 comprises a self-closing valve, meaning that when the second mating connector 115 is coupled to the bypass inlet tube 114 but is not coupled to another component distal from the bypass inlet tube 114, the second mating connector 115 remains in a normally closed configuration, preventing fluid from flowing out of the end of the second mating connector 115 distal from the bypass inlet tube 114. In one embodiment the second mating connector 115 is a male quick disconnect coupling, such as an ISO 16028 generic industry standard type coupling produced, for example by Snap-tite, Inc., although other suitable types of quick disconnect couplings are envisioned.

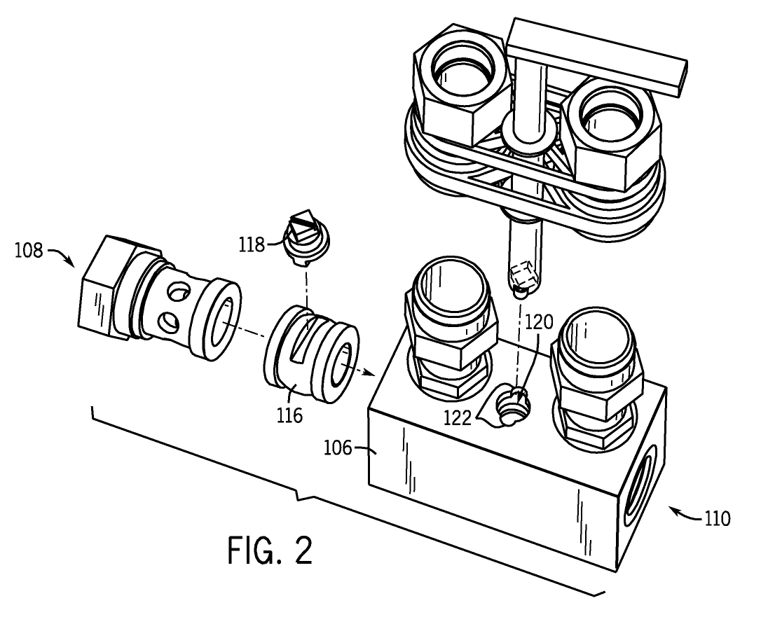

As is best illustrated in FIG. 2, the valve housing 106 further comprises a bypass valve 116. The bypass valve 116 is disposed within the fluid flow path between the inlet port 108 and the outlet port 110. In one embodiment the bypass valve 116 is a ball valve. In another embodiment the bypass valve is a flapper valve. Other suitable types of valves are contemplated. A valve stem 118, configured to manipulate the bypass valve 116, engages the top of the bypass valve 116.

The valve housing 106 further comprises a recessed aperture 120 through which access to the valve stem 118 is gained. The recessed aperture 120 has a key slot 122, which will be described further below. The combination of the recessed aperture 120 and the key slot 122, along with portions of the attachment portion which will be described further below, serve to function as an interlock mechanism, to prevent the bypass valve 116 from being configured into a closed configuration when the attachment portion 104 is not attached, as well as to prevent the attachment portion 104 from being decoupled from the fixed portion 102 when the bypass valve 116 is in an open configuration.

### Attachment Portion

Returning to FIG. 1, in one embodiment the attachment portion 104 includes a first attachment tube 124 and a second attachment tube 126 coupled together by a body sleeve 128. The body sleeve 128 maintains the first and second attachment tubes 124, 126 in a substantially spaced apart, parallel arrangement such that the first and second attachment tubes 124, 126 can be respectively simultaneously aligned with the bypass outlet tube 112 and the bypass inlet tube 114. Coupled to the first attachment tube 124 is a third mating connector 130 configured for engagement with the first mating connector 113 of the fixed portion 102. Coupled to the second attachment tube 126 is a fourth mating connector 132 configured for engagement with the second mating connector 115 of the fixed portion 102. At least one flow-through series component can be coupled to the first and second attachment tubes 124, 126 distal from the third and fourth mating connectors 130, 132 creating a flow path from the first attachment tube 124, through the at least one flow-through series component, and to the second attachment tube 126.

In one embodiment the third and fourth mating connectors 130, 132 are standard female quick disconnect valves, although other suitable types of mating connectors are envisioned. The third and fourth mating connectors 130, 132 may also comprise self-closing valves. The third and fourth mating connectors 130, 132 are configured such that when the third and fourth mating connectors 130, 132 are coupled to other suitable mating connectors or other suitable components, the third and fourth mating connectors 130, 132 can be released from their coupling with these other components by applying a force to the outside of the third and fourth mating connectors 130, 132 in an axial direction away from the attached other components causing the outer body of the third and fourth mating connectors 130, 132 to slidingly retract and thereby release the third and fourth mating connectors 130, 132 from their mating engagement with these other suitable components.

A band sleeve 134 surrounds both the third and fourth mating connectors 130, 132, such that by applying a force on the band sleeve 134, one could force the third and fourth mating connectors 130, 132 to slidingly retract simultaneously, thereby releasing the third and fourth mating connectors 130, 132 from their coupling to other suitable components simultaneously.

It is also contemplated that the configuration of the male quick disconnect couplings of the fixed portion 102 and the female quick disconnect valves of the attachment portion 104 could be reversed.

In the embodiment illustrated in FIG. 1, the attachment portion further comprises a valve lever handle 136. The valve lever handle 136 has an upper retaining ring 138 and a lower retaining ring 140. The valve lever handle 136 is slidingly retained within the body sleeve 128 and the band sleeve 134, with the upper retaining ring 138 configured above the body sleeve 128 and the lower retaining ring 140 configured below the band sleeve 134. The valve lever handle 136 is slidingly displaceable relative to the body sleeve 128 and the band sleeve 134 between a lower surface of the upper retaining ring 138 contacting the body sleeve 128 and an upper surface of the lower retaining ring 140 contacting band sleeve 134 as the valve lever handle 136 is slidingly displaced.

### Operation to Connect Attachment Portion to Fixed Portion

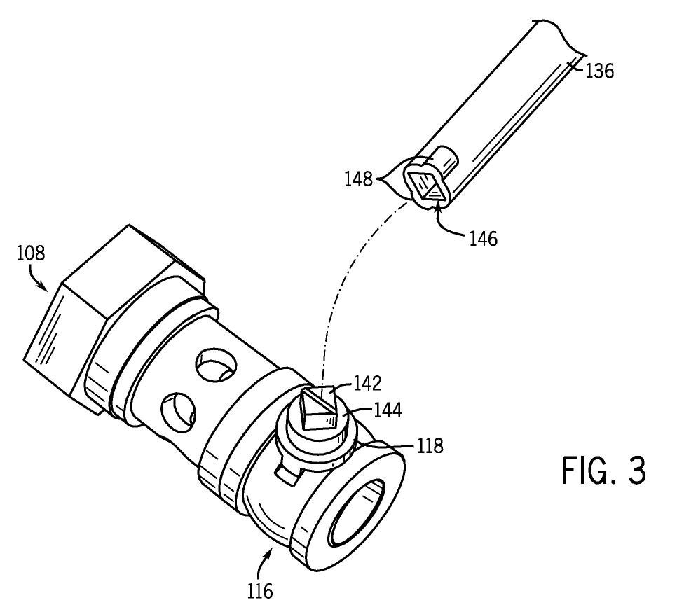

FIG. 3 illustrates the interaction between the bypass valve 116, the valve stem 118, and the valve lever handle 136. The valve stem 118 is in keyed interaction with the bypass valve 116. By turning the valve stem 118, the bypass valve 116 may be selectively moved from an open to a closed configuration or vice versa. The valve stem 118 includes a square protrusion 142 coupled to a radially extending flange 144. The valve lever handle 136 includes an associated corresponding square aperture 146 which fits over and around the square protrusion 142 of the valve stem 118 thereby operatively coupling the valve stem 118, and therefore the bypass valve 116, with the valve lever handle 136. The valve lever handle 136 also includes diametrically positioned lug keys 148.

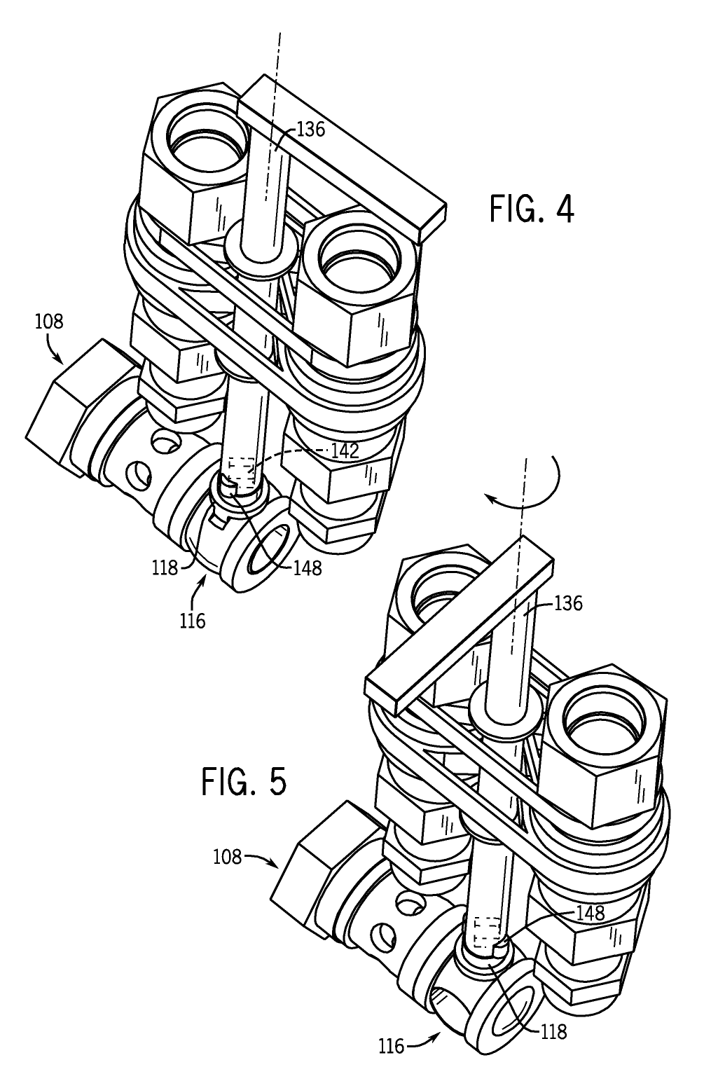

In FIG. 4, the bypass valve 116 is configured in an open position, allowing fluid to pass through the bypass valve 116 and the fluid path. In FIG. 5, the valve lever handle 136 has been rotated ninety degrees, which, because of the valve lever handle's 136 interaction with the square protrusion 142 (shown in dotted lines) of the valve stem 118, results in the valve stem 118 and, therefore the bypass valve 116, being similarly rotated ninety degrees. This results in the bypass valve 116 being configured in a closed configuration.

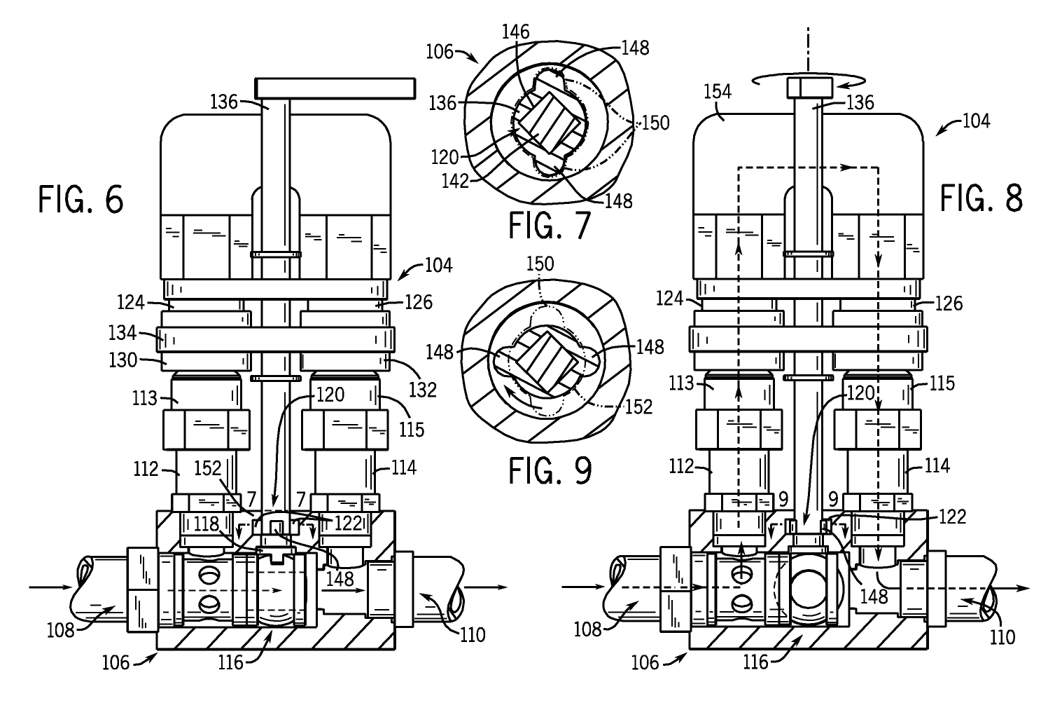

FIGS. 6-12 show an embodiment of a continuous flow bypass manifold from attachment to removal. FIG. 6 shows fluid flowing in the normal flow path from the fluidic system through the inlet port 108, through the valve housing 106, through the outlet port 110, and back into the fluidic system.

In FIG. 6 the third and fourth mating connectors 130, 132 of the attachment portion 104 are coupled to the first and second mating connectors 113, 115 of the fixed portion 102 respectively. By coupling the third and fourth mating connectors 130, 132 to the first and second mating connectors 113, 115, the first and second mating connectors 113, 115 are thereby configured in an open configuration by this connection. In this open configuration fluid may now pass through and out of the first and second mating connectors 113, 115. Therefore, the attachment portion 104 is placed in fluid communication with the flow path by this coupling.

The valve lever handle 136 is then inserted into the recessed aperture 120 in the top surface of the valve housing 106. As is best illustrated in FIG. 7, the recessed aperture 120 in the valve housing 106 has indentations 150 so that lug keys 148 of the valve lever handle 136 may pass into the recessed aperture 120, when properly aligned with indentations 150. The associated corresponding square aperture 146 is thereby allowed to engage the square protrusion 142 of the valve stem 118.

The recessed aperture 120 also defines a key slot 122. The key slot 122 is an undercut projecting radially outward from the recessed aperture 120, and defining a lip 152. When the valve lever handle 136 is turned, as in FIGS. 8 and 9, and the lug keys 148 on the valve lever handle 136 are turned, the lug keys 148 enter the key slot 122 underneath the lip 152, thereby preventing the lug keys 148 and consequently the valve lever handle 136 from being vertically displaced while the valve lever handle 136 is in the turned configuration as in FIGS. 8 and 9.

The second function of the interlock, as well as the manipulation of the bypass valve 116, are illustrated in FIG. 8. When the valve lever handle 136 is inserted and the associated corresponding square aperture 146 engages the square protrusion 146 of the valve stem 118, the valve lever handle 136 is then rotated ninety degrees resulting in the lug keys 148 entering the key slot 122 and the bypass valve 116 being turned ninety degrees to a closed configuration. As is illustrated in FIG. 8, in one embodiment of the continuous flow bypass manifold, the valve lever handle 136 cannot be removed from engagement with the valve stem 118 when the bypass valve 116 is in a closed configuration, as removal of the valve lever handle 136 is prevented by the lug keys 148 engagement with the key slot 122.

Once the valve lever handle 136 is rotated ninety degrees closing the bypass valve 116, fluid in flow path is no longer able to follow the flow path between inlet port 108 and outlet port 110. Fluid is instead diverted to an alternate pathway through bypass outlet tube 112, through first attachment tube 124, through at least one flow-through component 154, through second attachment tube 126, through bypass inlet tube 114, and back into the fluidic system through outlet port 110. Therefore, the at least one flow-through component 154 has been placed in series with the fluidic system without disassembling and reassembling the system. As long as the at least one flow-through component 154 is in series with the fluidic system, the attachment portion 104 cannot be removed using the valve lever handle 136.

Components that must be placed in series with a fluidic system, but are preferably added to the system only temporarily, can be added without interrupting fluid flow in the fluidic system, without introducing contaminants to the fluidic system, and without disassembling and reassembling even a portion of the fluidic system in this manner.

### Operation to Remove Attachment Portion from Fixed Portion

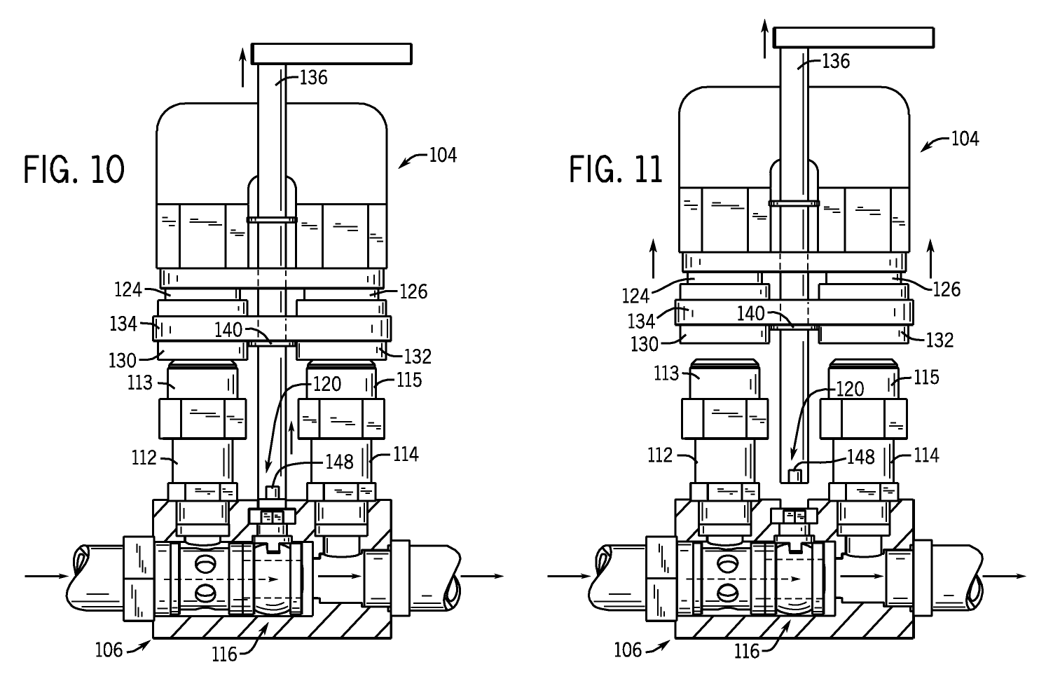

FIG. 10 illustrates removal of the attachment portion 104. The valve lever handle 136 is rotated ninety degrees to reopen the bypass valve 116 and align the lug keys 148 with the indentations 150 (not shown) of the recessed aperture 120. Fluid flow is no longer diverted by the bypass valve 116 and therefore returns to the flow path defined by the valve housing 106. A force is applied to the valve lever handle 136 in a direction away from the valve housing 106.

As the valve lever handle 136 pulls away from the valve housing 106, the lower retaining ring 140 engages the band sleeve 134, urging the band sleeve 134 in a direction away from the valve housing 106. The band sleeve 134 is in operative engagement with the third and fourth mating connectors 130, 132. Therefore, the third and fourth mating connectors 130, 132 are urged slidingly upward allowing the third and fourth mating connectors 130, 132 to disengage from the first and second mating connectors 113, 115. The third and fourth mating connectors 130, 132 are thereby allowed to detach from first and second mating connectors 113, 115 with the continued application of force away from the valve housing 106, as illustrated in FIG. 11. The first and second mating connectors 113, 115 are again configured in a closed configuration by the uncoupling of the third and fourth mating connectors 130, 132.

The present invention allows addition or removal of flow-through series components to or from a fluidic system.

It allows addition or removal of flow-through series components to or from a fluidic system without disassembling and/or reassembling the fluidic system.

Further, it allows addition or removal of flow-through series components to or from a fluidic system without disrupting or being forced to discontinue the fluid flow through the fluidic system for a period of time.

It also allows addition or removal of flow-through series components to or from a fluidic system without the loss of any fluid from the system.

It also allows addition or removal of flow-through series components to or from a fluidic system by a controlled method that would prevent the ingress of any contaminants into the fluid.

It also allows addition or removal of flow-through, series components to or from a fluidic system in such a way as to prevent removal of the flow-through, series components without returning the flow path to normal state.

For purposes of this disclosure, the term “coupled” means the joining of two components (electrical or mechanical) directly or indirectly to one another. Such joining may be stationary in nature moveable in nature. Such joining may be achieved with the two components (electrical or mechanical) and any additional intermediate members being integrally formed as a single unitary body with one another or the two components and any additional member being attached to one another. Such adjoining may be permanent in nature or alternatively be removable or releasable in nature.

The continuous flow bypass manifold is of a construction which is both durable and long lasting, and it should also require little or no maintenance to be provided by the user throughout its operating lifetime. The continuous flow bypass manifold is also of relatively inexpensive construction to enhance its market appeal and to thereby afford it the broadest possible market. Finally, the continuous flow bypass manifold achieves all of the aforesaid advantages and objectives without incurring any substantial relative disadvantage. While at least one flow-through series component has been described as attached to the attachment tubes, it is also contemplated that multiple flow-through series components could be added in series or in parallel with each other in place of the at least one flow-through series component in the system described.

Although the foregoing description of the continuous flow bypass manifold and method has been shown and described with reference to particular embodiments and applications thereof; it has been presented for purposes of illustration and description and is not intended to be exhaustive or to limit the invention to the particular embodiments and applications disclosed. It will be apparent to those having ordinary skill in the art that a number of changes, modifications, variations, or alterations to the invention as described herein may be made, none of which depart from the spirit or scope of the continuous flow bypass manifold and method. The particular embodiments and applications were chosen and described to provide the best illustration of the principles of the continuous flow bypass manifold and its practical application to thereby enable one of ordinary skill in the art to utilize the continuous flow bypass manifold in various embodiments and with various modifications as are suited to the particular use contemplated. All such changes, modifications, variations, and alterations should therefore be seen as being within the scope of the continuous flow bypass manifold and method as determined by the appended claims when interpreted in accordance with the breadth to which they are fairly, legally, and equitably entitled.

What is claimed is:

1. A flow bypass manifold coupled in series with a fluidic system containing a fluid, the flow bypass manifold comprising:
a fixed section comprising
a valve housing having an inlet port and an outlet port that define a flow path therebetween;
a bypass valve located in said valve housing intermediate said inlet port and said outlet port;
a bypass outlet tube located in said valve housing proximate said inlet port, said bypass outlet tube being in fluid communication with said inlet port; and
a bypass inlet tube located in said valve housing proximate said outlet port, said bypass inlet being in fluid communication with said outlet port;
wherein when said bypass valve is in an open configuration, the fluid passes through said flow path; and
an attachment portion comprising a first attachment tube and a second attachment tube, said second attachment tube coupled to and spaced apart from said first attachment tube;
wherein said first and second attachment tubes are configured to have at least one flow-through component attached therebetween;
wherein when said attachment portion is removably coupled to said fixed portion, said bypass valve is in a closed configuration, and said at least one flow-through component is attached to said attachment portion, the fluid is diverted through said bypass outlet tube, through said first attachment tube, through said at least one flow-through series component, through said second attachment tube, through said bypass inlet tube, and into the fluidic system.

2. The flow bypass manifold of claim 1, further comprising an interlock mechanism integrally formed in said valve housing proximate said bypass valve;
wherein said interlock mechanism prevents said bypass valve from being configured in a closed configuration when said attachment portion is not attached to said fixed portion; and
wherein said interlock mechanism prevents said attachment portion from being decoupled from said fixed portion when said bypass valve is in an open configuration.

3. The flow bypass manifold of claim 1, wherein said bypass valve is a ball valve.

4. The flow bypass manifold of claim 1, further comprising a valve lever handle coupled to said first and second attachment tubes;
wherein said valve lever handle is configured to selectively engage said valve housing; and
wherein said valve lever handle is configured to selectively open and close said bypass valve.

5. The flow bypass manifold of claim 3, wherein said valve lever handle is prevented by said valve housing from disengaging from said valve housing when said bypass valve is in a closed configuration.

6. The flow bypass manifold of claim 1, wherein said bypass outlet tube further comprises a first male quick disconnect coupling; and
said bypass inlet tube further comprises a second male quick disconnect coupling.

7. The flow bypass manifold of claim 1, wherein said first attachment tube further comprises a first female quick disconnect valve; and
wherein said second attachment tube further comprises a second female quick disconnect valve.

8. The flow bypass manifold of claim 7, wherein said first and second female quick disconnect valves comprise first and second slide release sleeves;
wherein said first and second female quick disconnect valves are positioned relative to one another by a band sleeve; and
wherein said band sleeve engages said first and second release sleeves such that said first and second release sleeves may be slidably maneuvered by placing a force on said band sleeve.

9. The flow bypass manifold of claim 1, wherein said at least one flow-through, series component comprises a filtration implement.

10. A flow bypass manifold for coupling in series with a fluidic system containing a fluid, the manifold comprising:
a valve housing defining a flow path and including an inlet port and an outlet port;
a bypass apparatus selectively coupled to said valve housing including a first bypass tube proximate said inlet port and a second bypass tube proximate said outlet port;
wherein each bypass tube is in fluid communication with said flow path; and
a bypass valve operatively coupled to said valve housing and disposed in said flow path between said inlet port and said outlet port, said bypass valve configured to one of open and close said flow path;
wherein with said bypass valve open said flow path passes the fluid; and
an interlock mechanism integrally formed in said valve housing proximate said bypass valve;
wherein said interlock mechanism prevents said bypass valve from being configured in a closed configuration when said attachment portion is not attached to said fixed portion;
wherein said interlock mechanism prevents said bypass apparatus from being decoupled from said valve housing when said bypass valve is in an open configuration;
wherein with said bypass valve closed, the fluid is directed through said first and second bypass tubes; and
wherein the addition or removal of said bypass apparatus does not interrupt flow of the fluid in the fluidic system.

11. The flow bypass manifold of claims 10, further comprising a flow-through series component coupled to said bypass apparatus.

12. The flow bypass manifold of claim 10, further comprising a valve lever handle selectively coupled to the bypass valve;
said valve lever configured to manipulate said bypass valve between an open configuration and a closed configuration;
said valve lever configured to selectively interlock with said bypass apparatus.

13. The flow bypass manifold of claim 10, further comprising at least one male quick-connect coupling releasably coupled to each of said first and second bypass tubes and in fluid communication with said flow path.

14. The flow bypass manifold of claim 13, further comprising at least one female quick-connect valve configured to engage one of said at least one male quick-connect coupling coupled to one of said first and second bypass tubes;
wherein said flow-through, series component is in series fluid communication with said flow path.

15. The flow bypass manifold of claim 14, wherein a band sleeve couples said attachment tubes;
wherein said at least one female quick-connect valve further comprises at least one slide release sleeve for slidably releasing said at least one female quick-connect valve from said at least one male quick-connect coupling; and
wherein said band sleeve is configured to engage said at least one slide release sleeve such that a user may detach said at least one female quick-connect valve from said at least one male quick-connect coupling by applying a force to said band sleeve.

16. A method of placing a flow-through component in series with a fluidic system having a fluid flowing through the fluidic system, the method comprising:
fixedly installing a fixed portion in series with a fluidic system;
said fixed portion comprising a valve housing having an inlet port and an outlet port that define a flow path therebetween;
a bypass valve located in said valve housing intermediate said inlet port and said outlet port;
a bypass outlet tube located in said valve housing proximate said inlet port, said bypass outlet tube being in fluid communication with said inlet port; and
a bypass inlet tube located in said valve housing proximate said outlet port, said bypass inlet being in fluid communication with said outlet port;
providing an attachment portion;
said attachment portion defining an alternate flow path and comprising
a first attachment tube;
a second attachment tube;
at least one flow-through series component;
coupling said attachment portion to said fixed portion by coupling said first attachment tube to said bypass outlet tube and coupling said second attachment tube to said bypass inlet tube; and
manipulating said bypass valve to configure said bypass valve in a closed configuration, wherein said flow path is closed, and the fluid is forced to flow through said alternate flow path; and
providing an interlock mechanism integrally formed in said valve housing proximate said bypass valve;
wherein said interlock mechanism prevents said bypass valve from being configured in a closed configuration when said attachment portion is not attached to said fixed portion;
wherein said interlock mechanism prevents said bypass apparatus from being decoupled from said valve housing when said bypass valve is in an open configuration;
wherein with said bypass valve closed, the fluid is directed through said first and second bypass tubes; and
wherein flow of the fluid need not be interrupted by any step of the method.

17. The method of claim 16, wherein said bypass valve is a ball valve.

18. The method of claim 16, further comprising providing a valve lever handle for manipulating said bypass valve between an open and said closed configurations.

19. The method of claim 16, wherein said at least one flow-through series component is a filtration element.

20. A method of diverting flow of a fluid flowing through a fluidic system through a flow-through series component without disrupting the flow of the fluid in the system, the method comprising:
fixedly installing a fixed portion in series with the fluidic system;
said fixed portion defining a flow path, and said fixed portion comprising
an inlet port;
an outlet port;
a bypass valve disposed in said flow path;
providing an attachment portion;
said attachment portion defining an alternate flow path, and said attachment portion comprising
a first bypass tube;
a second bypass tube;
at least one flow-through, series component;
wherein said first bypass tube and said second bypass are operably coupled in fluid communication with said at least one flow-through series component;
selectively placing said first bypass tube in fluid communication with said flow path proximate said inlet port;
selectively placing said second bypass tube in fluid communication with said flow path proximate said outlet port;
selectively closing said bypass valve.
